(19) United States
(12) Patent Application Publication
(10) Pub. No.: US 2014/0067095 A1
(43) Pub. Date: Mar. 6, 2014

(54) COOKING APPLIANCE

(71) Applicants: Daniel Anton Falcon, Zaragoza (ES); Miguel Angel Bunuel Magdalena, Zaragoza (ES); Jose Maria De la Cuerda Ortin, Zaragoza (ES); Jose Ramon Garcia Jimenez, Augsburg (ES); Jose Andres Garcia Martinez, Zaragoza (ES); Ignacio Garde Aranda, Zaragoza (ES); Pablo Jesus Hernandez Blasco, Cuarte de Huerva (Zaragoza) (ES); Sergio Llorente Gil, Zaragoza (ES); Alfonso Lorente Perez, Zaragoza (ES); Paul Muresan, La Cartuja (ES); David Ortiz Sainz, Pinseque (Zaragoza) (ES); Ramon Peinado Adiego, Zaragoza (ES); Carmelo Pina Gadea, Zaragoza (ES); Diego Puyal Puente, Zaragoza (ES); Julio Rivera Peman, Cuarte de Huerva (Zaragoza) (ES)

(72) Inventors: Daniel Anton Falcon, Zaragoza (ES); Miguel Angel Bunuel Magdalena, Zaragoza (ES); Jose Maria De la Cuerda Ortin, Zaragoza (ES); Jose Ramon Garcia Jimenez, Augsburg (ES); Jose Andres Garcia Martinez, Zaragoza (ES); Ignacio Garde Aranda, Zaragoza (ES); Pablo Jesus Hernandez Blasco, Cuarte de Huerva (Zaragoza) (ES); Sergio Llorente Gil, Zaragoza (ES); Alfonso Lorente Perez, Zaragoza (ES); Paul Muresan, La Cartuja (ES); David Ortiz Sainz, Pinseque (Zaragoza) (ES); Ramon Peinado Adiego, Zaragoza (ES); Carmelo Pina Gadea, Zaragoza (ES); Diego Puyal Puente, Zaragoza (ES); Julio Rivera Peman, Cuarte de Huerva (Zaragoza) (ES)

(73) Assignee: BSH BOSCH UND SIEMENS HAUSGERÄTE GMBH, Munich (DE)

(21) Appl. No.: 14/115,906

(22) PCT Filed: May 9, 2012
(86) PCT No.: PCT/IB2012/052293

§ 371 Date: Nov. 6, 2013

(30) Foreign Application Priority Data
May 19, 2011 (ES) P201130805

(51) Int. Cl. G05B 15/02

(52) U.S. Cl. CPC G05B 15/02
USPC 700/90

(57) ABSTRACT

A cooking appliance apparatus includes a power unit, and a communication unit which is configured to receive at least one information item from a data network. A control unit is operably connected to the communication unit and configured to change at least one operating parameter of the power unit at least as a function of the at least one information item.

Dishwashers, washing machines and tumble dryers are known, which can be connected to an intelligent power network and have a corresponding communication unit allowing the sending of data to and the receiving of data from the intelligent power network. This allows an operating cycle to be started with a time delay so that power is only taken from a power network when the consumer load on the power network is relatively small.

The object of the invention is in particular to provide a cooking appliance apparatus having improved characteristics in respect of ease of operation. According to the invention the object is achieved by the features of claim 1 and the method claim 9. Advantageous embodiments and developments of the invention will emerge from the subclaims.

A cooking appliance apparatus, in particular a cooktop apparatus, is proposed, having a power unit, a communication unit for receiving at least one information item from a data network and a control unit, which is provided to change at least one operating parameter of the power unit at least as a function of the at least one information item. “Provided” here means in particular specifically designed and/or equipped and/or programmed. A “power unit” refers in particular to the unit of a cooking appliance which has a maximum power uptake in at least one operating state and is preferably provided for heating purposes. A “communication unit” refers in particular to a unit that is different from an input unit and communicates with other devices, in particular a computation unit that is different from the control unit and/or a power meter, in particular by way of cable and preferably at least partially without cable, and which in particular obtains at least one information item from there. In particular the other device is a device in a data network, in particular in the internet and/or in a domestic network and/or in an intelligent power network. An “input unit” here and in the following refers in particular to an operating unit, which is provided to allow an operator to input and/or change an operating parameter. The input unit is preferably provided for manual inputting and/or changing, in particular by means of operating elements provided for the purpose. An “intelligent power network” refers in particular to a communication-based networking and/or control of power generators, electrical energy storage units, electrical consumers and/or network operating means in energy transmission networks and/or energy distribution networks of an electricity supply. A “control unit” refers in particular to a unit, which is provided to control and/or regulate the power unit. The control unit preferably comprises a computation unit, in particular a microprocessor unit, and in particular a storage unit that is different from the computation unit, in which a control and/or regulation program is particularly advantageously stored. An “operating parameter” refers in particular to a physical variable of an operating state of the power unit. A value of the operating parameter is preferably always different from zero. The operating parameter is in particular different from a logical variable, which can in particular only have two values. The operating parameter is in particular different from a logical variable, which characterizes an activation state of the power unit. Such an embodiment allows an advantageously greater ease of operation to be achieved. In particular it allows remote control and/or remote maintenance of a cooking appliance comprising the cooking appliance apparatus.

In one preferred embodiment of the invention it is proposed that the at least one operating parameter is a power parameter, which sets a maximum power of the power unit. The power parameter is preferably a maximum electric current that can be supplied as a maximum to the power unit, in particular by a power supply of a private household. This allows automatic adjustment of a maximum power of a cooking appliance, in particular to a domestic electrical installation. In particular data relating to the available maximum power of individual consumers connected to the domestic installation can be available in the data network, allowing the communication unit to access said data.

In one particularly preferred embodiment of the invention it is proposed that the communication unit is provided to connect the control unit to an intelligent power network. This can reduce energy costs, as a specified power can be supplied as a maximum to the power unit as a function of the availability of electric power in the power network and therefore as a function of price per unit of electrical energy. If the cooking appliance is configured as an oven with a pyrolysis function, pyrolytic self-cleaning can preferably take place when there is a relatively high availability of electric power in the power network. Also, in the event of a power quota system, when an overall power consumption of all the consumers connected to a domestic installation is to be below a limit value, a maximum power of the cooking appliance can be limited to comply with the limit value.

It is further proposed that the cooking appliance apparatus has an input unit for inputting operating parameters of the power unit. This allows ease of operation to be particularly advantageously enhanced, as a setting for the at least one operating parameter obtained by the communication unit can be overwritten by an operator if required. Thus for example an operator can increase a power parameter manually if this is necessary for a cooking process.

The control unit is advantageously provided to change the at least one operating parameter of the power unit at least as a function of at least one information item which the control unit obtains by way of the input unit. This allows ease of operation to be advantageously enhanced, as an operator can perform manual overwriting of the power parameter if the power parameter of the power unit is disadvantageously low.

In a further embodiment of the invention it is proposed that the cooking appliance apparatus comprises an output unit for outputting operating parameters of the power unit. An “output unit” refers in particular to a unit, which is provided for the optical and/or acoustic and/or tactile and/or electronic outputting of an operating parameter. The output unit preferably comprises a display unit, preferably an LCD display, and/or a communication interface, which is provided for the electronic outputting of the operating parameter. The communication interface advantageously supplies the operating parameter in an electronically encoded manner so that it can be read electronically, in particular by a computation unit and preferably for further processing by the computation unit. This creates an advantageous transparency for an operator so that said operator is informed about the operating state of the power unit at all times and can intervene by way of the input unit if required.

The control unit is advantageously provided to output a current value of the at least one operating parameter by way of the output unit. This allows an advantageously high level of ease of operation to be achieved, as an operator can obtain information about the operating parameter at any time.

It is further proposed that the communication unit is configured at least partially as a single piece with the control unit. The statement that “the communication unit is configured at least partially as a single piece with the control unit” suggests in particular that the communication unit is integrated at least partially in the control unit. The communication unit and control unit are preferably disposed within a single electronic module and preferably on a single electronic printed circuit board. This can advantageously reduce the material and assembly outlay. It also reduces weight.

A method with an inventive cooking appliance apparatus, in particular a cooktop apparatus, having a power unit is also proposed, wherein at least one information item is received from a data network and at least one operating parameter of the power unit is changed at least as a function of the at least one information item.

A cooking appliance, in particular a cooktop, having an inventive cooking appliance apparatus is also proposed.

Further advantages will emerge from the description of the drawing which follows. An exemplary embodiment of the invention is illustrated in the drawing. The drawing, description and claims contain numerous features in combination. The person skilled in the art will expediently also consider the features individually and bring them together to form useful further combinations.

In the drawing:

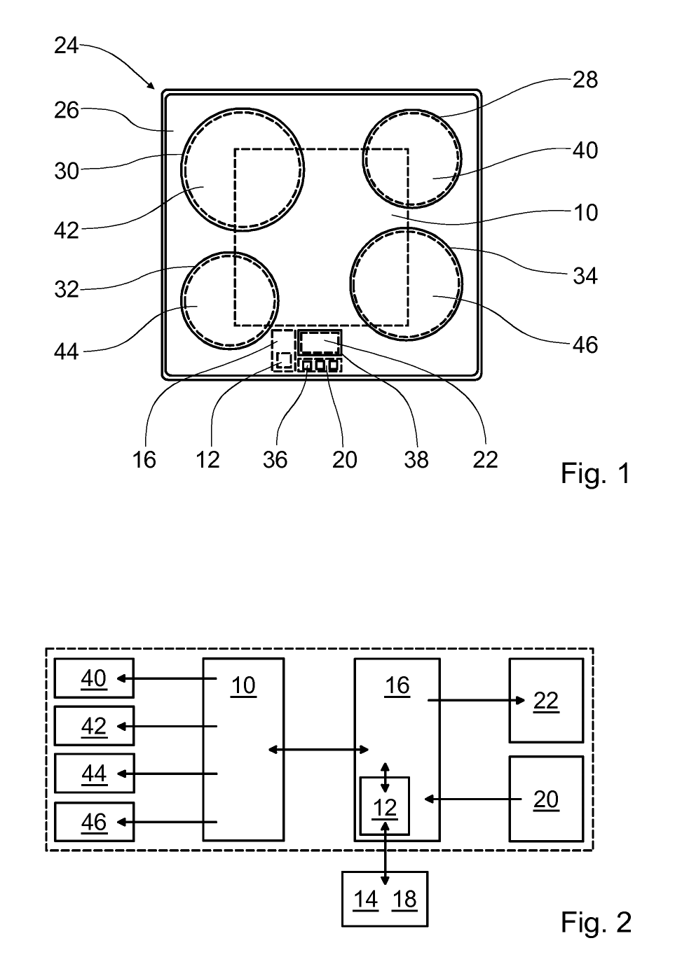

FIG. 1 shows a schematic plan view of a cooking appliance having an inventive cooking appliance apparatus and

FIG. 2 shows a schematic block diagram of the cooking appliance apparatus.

FIG. 1 shows a schematic plan view of a cooking appliance configured as a cooktop 24. The cooktop 24 comprises a cooktop plate 26, made in particular of a glass ceramic, on which heating zones 28, 30, 32, 34 are marked in the known manner. The cooktop plate 26 is disposed horizontally when the cooktop 24 is ready to operate and is provided to have cookware positioned on it. Touch-sensitive operating elements 36 and a display element 38 are also marked on the cooktop plate 26 in the known manner. The cooking appliance configured as a cooktop 24 further comprises a cooking appliance apparatus disposed below the cooktop plate 26 (components disposed below the cooktop plate 26 are shown with a broken line in FIG. 1). The cooking appliance apparatus comprises a power unit 10, a communication unit 12, a control unit 16, an input unit 20 and an output unit 22. In at least one operating state the power unit 10 supplies heating units 40, 42, 44, 46 of the cooking appliance apparatus assigned to the heating zones 28, 30, 32, 34 with electrical energy. The heating units 40, 42, 44, 46 can be any electrical heating units 40, 42, 44, 46 that appear expedient to the person skilled in the art, in particular resistance heating units, radiant heating units and preferably induction heating units. The communication unit 12 is embodied as a single piece with the control unit 16. The communication unit 12 is provided for connection to a data network 14, specifically to an intelligent power network 18 (see FIG. 2). The touch-sensitive operating elements 36 marked on the cooktop plate 26 are actively connected to the input unit 20 in a capacitive manner. The touching of the operating elements 36 by an operator's finger is registered by the input unit 20 in the known manner. The input unit 20 is used to input operating parameters of the power unit 10. The display element 38 marked on the cooktop plate 26 is part of the output unit 22 and is used to output operating parameters of the power unit 10.

FIG. 2 shows a schematic block diagram of the cooking appliance apparatus. In at least one operating state the communication unit 12 receives an information item from the data network 14 and transmits it to the control unit 16. The control unit 16 changes an operating parameter of the power unit 10 as a function of the information item. The information item can be a value of the operating parameter or a request to increase or reduce the operating parameter. The operating parameter can be any operating parameter of the power unit 10 that appears expedient to the person skilled in the art. However the operating parameter is preferably a power parameter, which sets a maximum power of the power unit 10. At a constant power supply network root mean square voltage this corresponds to setting a maximum root mean square current. The control unit 16 outputs the operating parameter to an operator by way of the output unit 22. Said operator is able to use the input unit 20 to manually overwrite the operating parameter determined from the data network 14. During operation of the heating units 40, 42, 44, 46 supplied with energy by the power unit 10 the control unit 16 ensures that an overall power uptake of the power unit 10 corresponds at most to the power parameter. The heating units 40, 42, 44, 46 are operated if required at an actual power below a setpoint power, it being possible for a decision as to which of the heating units 40, 42, 44, 46 should have their power reduced to be taken on any basis that appears expedient to the person skilled in the art. It can thus be left to the operator to decide which of the heating units 40, 42, 44, 46 should have their power reduced. Alternatively the power of the heating units 40, 42, 44, 46 can also be reduced in a uniform manner. It is also conceivable for the heating units 40, 42, 44, 46 to be prioritized automatically, for example based on an activation period, setpoint power and/or a cooking program of the heating unit 40, 42, 44, 46 in question.

### REFERENCE CHARACTERS

10 Power unit
12 Communication unit
14 Data network
16 Control unit
18 Intelligent power network
20 Input unit
22 Output unit
24 Cooktop
26 Cooktop plate
28 Heating zone
30 Heating zone
32 Heating zone
34 Heating zone
36 Operating element
38 Display element
40 Heating unit
42 Heating unit
44 Heating unit
46 Heating unit

1-10. (canceled)

11. A cooking appliance apparatus, comprising:
a power unit,
a communication unit configured to receive at least one information item from a data network, and
a control unit operably connected to the communication unit and configured to change at least one operating parameter of the power unit at least as a function of the at least one information item.

12. The cooking appliance apparatus of claim 11, constructed in the from of a cooktop apparatus.

13. The cooking appliance apparatus of claim 11, wherein the at least one operating parameter is a power parameter, which sets a maximum power of the power unit.

14. The cooking appliance apparatus of claim 11, wherein the communication unit is configured to connect the control unit to an intelligent power network.

15. The cooking appliance apparatus of claim 11, further comprising an input unit configured to input the at least one operating parameter of the power unit.

16. The cooking appliance apparatus of claim 15, wherein the control unit is operably connected to the input unit to receive the at least one information item and to change the at least one operating parameter of the power unit at least as a function of the at least one information item.

17. The cooking appliance apparatus of claim 11, further comprising an output unit configured to output the at least one operating parameter of the power unit.

18. The cooking appliance apparatus of claim 17, wherein the control unit is configured to output a current value of the at least one operating parameter by way of the output unit.

19. The cooking appliance apparatus of claim 11, wherein the communication unit is configured at least partially as a single piece with the control unit.

20. A method, comprising:
receiving at least one information item from a data network of a cooking appliance apparatus; and
changing at least one operating parameter of a power unit of the cooking appliance apparatus at least as a function of the at least one information item.

21. The method of claim 20, wherein the at least one operating parameter is a power parameter, which sets a maximum power of the power unit.

22. The method of claim 20, further comprising inputting the at least one operating parameter of the power unit by way of an input unit of the cooking appliance apparatus.

23. The method of claim 20, further comprising outputting the at least one operating parameter of the power unit by way of an output unit of the cooking appliance apparatus.

24. The method of claim 23, wherein the outputting step includes outputting a current value of the at least one operating parameter by way of the output unit.

25. A cooking appliance, comprising a cooking appliance apparatus having a power unit, a communication unit configured to receive at least one information item from a data network, and a control unit operably connected to the communication unit and configured to change at least one operating parameter of the power unit at least as a function of the at least one information item.

26. The cooking appliance of claim 25, constructed in the form of a cooktop.

27. The cooking appliance of claim 25, wherein the at least one operating parameter is a power parameter, which sets a maximum power of the power unit.

28. The cooking appliance of claim 25, wherein the communication unit is configured to connect the control unit to an intelligent power network.

29. The cooking appliance of claim 25, wherein the cooking appliance apparatus includes an input unit configured to input the at least one operating parameter of the power unit.

30. The cooking appliance of claim 29, wherein the control unit is operably connected to the input unit to receive the at least one information item and to change the at least one operating parameter of the power unit at least as a function of the at least one information item.

31. The cooking appliance of claim 25, wherein the cooking appliance apparatus includes an output unit configured to output the at least one operating parameter of the power unit.

32. The cooking appliance of claim 31, wherein the control unit is configured to output a current value of the at least one operating parameter by way of the output unit.

33. The cooking appliance of claim 25, wherein the communication unit is configured at least partially as a single piece with the control unit.
